(19) United States
(12) Patent Application Publication
(10) Pub. No.: US 2011/0298605 A1
(43) Pub. Date: Dec. 8, 2011

(54) ALARM LIGHT STRUCTURE

(76) Inventor: TUNG-LIN LU, Yonghe City (TW)

(21) Appl. No.: 12/792,753

(22) Filed: Jun. 3, 2010

(51) Int. Cl. B60Q 1/00

(52) U.S. Cl. 340/438

(57) ABSTRACT

An alarm light includes at least one light emission element, a control unit, and a central lock unit. The light emission element is mounted to a vehicle. The control unit is electrically connected to the light emission unit to control the light emission unit to selectively give off light. When the central lock unit is unlocked, the control unit controls the light emission element to give off light and when the central lock unit is locked, the control unit controls the light emission element to stop lighting. As such, the alarm light may signal vehicles and pedestrians coming from the rear side in advance that a vehicle door is going to be opened.

### (a) TECHNICAL FIELD OF THE INVENTION

The present invention generally relates to an alarm light, and more particularly to an alarm light structure that is mounted to a vehicle to provide an alarm to vehicles and pedestrians coming from the rear side for reducing speed and keeping distance when a door of the vehicle is to be opened.

### (b) DESCRIPTION OF THE PRIOR ART

Due to the highly development of industry, various transportations are now available. Besides public transportation, the most commonly used transportation is passenger cars.

However, the cars or automobiles show certain drawbacks in serving as transportation, which will be briefly identified as follows.

In certain areas, the convenience in use makes motorcycles a popular transportation means. It is often found in an area where motorcycles and cars are both heavily relied upon as major transportation means that motorcycles and cars compete on roads. For example, when a car is parked by a road and the drivers opens the door, attempting to step down the car, a motorcycle coming from the rear side may accidentally hit the car door if the door is opened very suddenly or in better situations, the motorcycle rider gets shocked by the suddenly-opening door. Such a situation often leads to falling of motorcycles or other pedestrians, who may then be hit by other moving vehicles and more severe causality and damage may encounter.

In view of the above mentioned problems, the present invention aims to provide an alarm light to overcome such problems.

### SUMMARY OF THE INVENTION

The present invention aims to provide an alarm light to issues an alarm signal to vehicles and pedestrians coming from the rear side to reducing speed and keeping distance from a parked vehicle.

The primary objective of the present invention is to provide an alarm light structure that is mounted to a vehicle to issue an alarm signal to a vehicle or a pedestrian who is approaching from the rear side for reducing moving speed or keeping a proper distance when the vehicle stops and a vehicle door is being opened.

A secondary objective of the present invention is to provide an alarm light structure that is mounted to a vehicle to remind a driver of the vehicle to actuate a central lock unit of the vehicle.

To achieve the above objectives, according to the present invention, an alarm light structure is provided, comprising at least one light emission element, a control unit, and a central lock unit. The light emission element is mounted to a vehicle body. The control unit is electrically connected to the light emission element and controls actuation of the light emission element to light. The central lock unit functions to lock/unlock door locks of vehicle doors and is electrically connected to the control unit, whereby when the central lock unit is unlocked, the control unit controls the light emission element to give off light and when the central lock unit is locked, the control unit controls the light emission element to stop lighting.

According to the present invention, the control unit provides control for actuation/de-actuation of the light emission element to give off light and the central lock unit is in electrical connection with the control unit. When the central lock unit is unlocked, the control unit actuates the light emission element to give off light, and when the central lock unit is locked, the control unit controls the light emission element to stop lighting. With such an arrangement, when a vehicle driver stops a vehicle and unlocks the central lock unit, it means doors of the vehicle will be opened at any time shortly and the central lock unit commands the light emission element to give off light. As such, it is possible to effectively signal vehicles and pedestrians coming from the rear side to reduce speed. In view of the problem of the conventional alarm device that issues an alarm only after the vehicle door has already been opened, the present invention provides an alarm signal to the vehicles and pedestrians coming from the rear side before the vehicle door is actually open and thus shows significant improvement over the conventional technology.

Further, since when the central lock unit is locked, the central lock unit commands the control unit to control the light emission element to stop lighting, when a vehicle driver leaves the vehicle without properly locking the central lock unit, the driver may easily find such a mistake by viewing the lighting of the light emission element. In view of the problem of the conventional alarm device that is hard to identify if the central lock unit is properly locked, the present invention allows a user to easily identify if the central lock unit is properly locked by viewing the light emission element and thus shows significant improvement over the conventional technology.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an alarm light structure according to an embodiment of the present invention.

FIG. 2 is a perspective view showing an alarm light structure according to another embodiment of the present invention.

FIG. 3 is a perspective view showing the operation of the alarm light structure according to an embodiment of the present invention.

FIG. 4 is a perspective view showing the operation of the alarm light structure according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

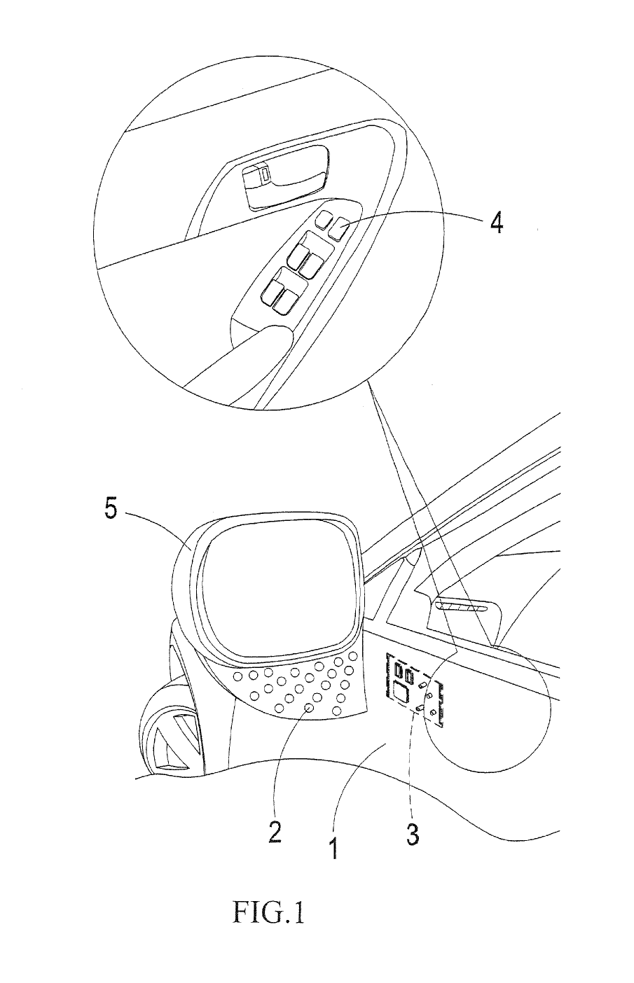

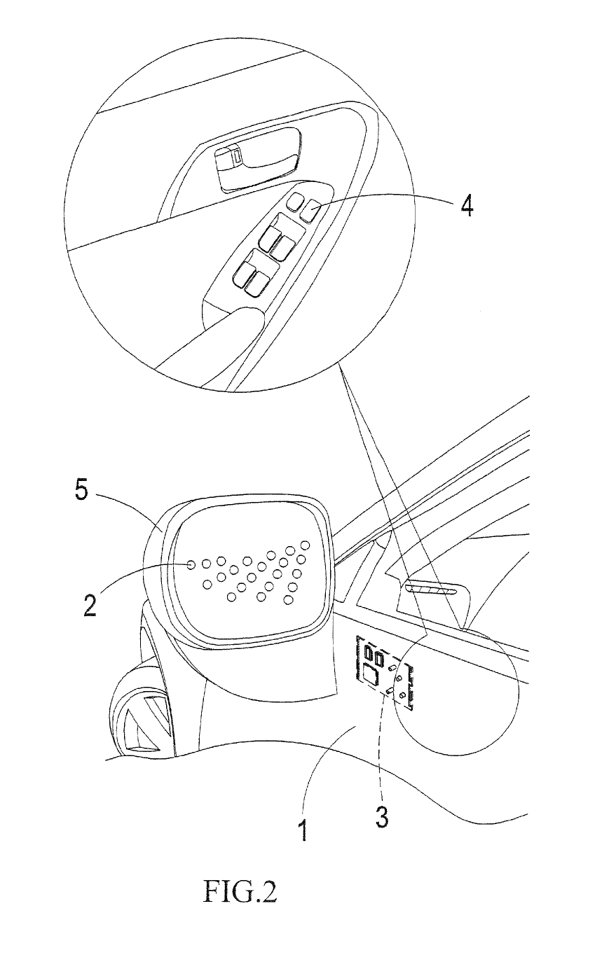

Referring to FIGS. 1 and 2, perspective views showing embodiments of alarm light structure according to the present invention are illustrated. The alarm light structure comprises constituent components that will be described as follows.

At least one light emission element 2 is mounted to a vehicle body 1. Preferably, the light emission element 2 comprises a light-emitting diode, which is mounted to the vehicle body 1 below a rearview mirror 5 (as shown in FIG. 1) or is alternatively mounted in the rearview mirror 5 (as shown in FIG. 2). Preferably, a plurality of light-emitting diodes is included in the alarm light structure of the present invention and the light-emitting diodes can be arranged as an array or matrix or a line.

A control unit 3 is electrically connected to the light emission element 2. The control unit 3 controls the operation of the light emission element 2 for emission of light, such as flashing.

A central lock unit 4 is provided in the vehicle for controlling locking/unlocking of door locks of the vehicle. The central lock unit 4 is in electrical connection with the control unit 3, whereby when the central lock unit 4 is unlocked, the control unit 3 actuates the light emission element 2 to give off light and when the central lock unit 4 is locked, the control unit 3 controls the light emission element 2 to stop lighting. Here, it is understood that the central lock unit 4 may refer or comprise a door lock of any door of the vehicle.

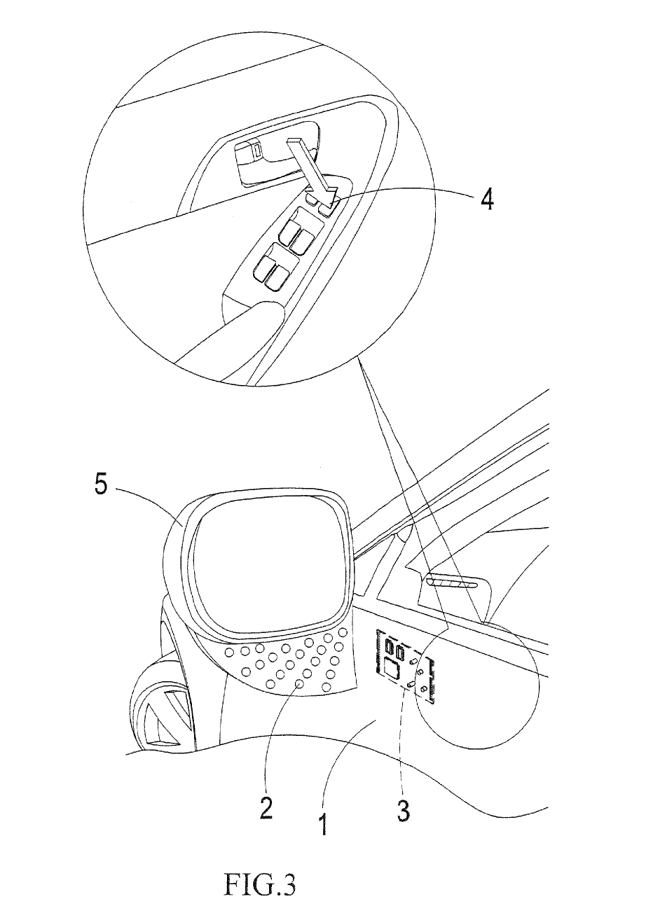

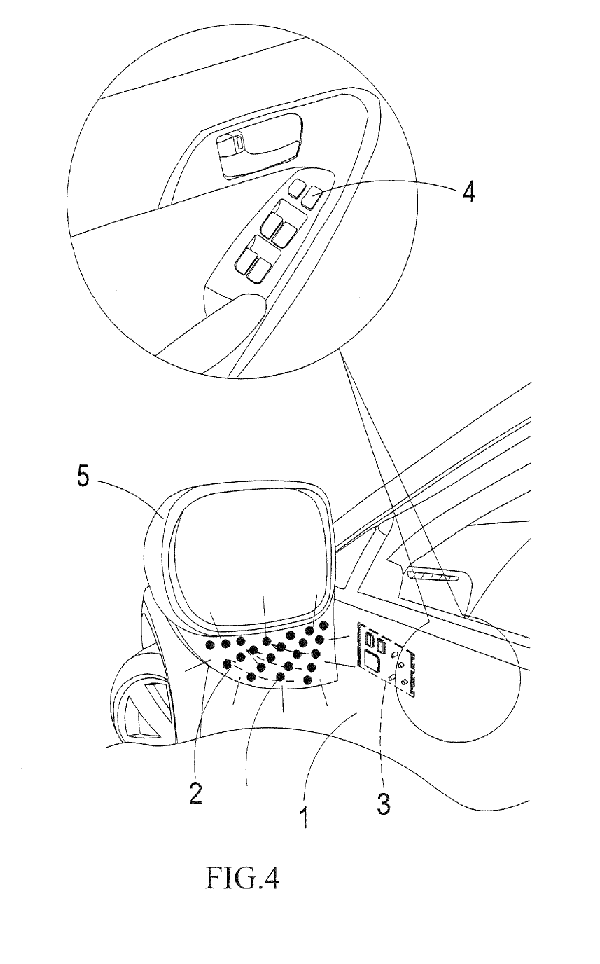

With such an arrangement, the operation of the alarm light structure according to the present invention is described as follows. Reference is also made to FIGS. 3 and 4, which respectively show the operations of the embodiments illustrated in FIGS. 1 and 2. As shown in the drawings, the central lock unit 4 is electrically connected to the control unit 3, which controls the operation of the light emission element 2 for light emission. When the drives stops the vehicle and unlocks the central lock unit 4, all the vehicle doors are unlocked and passengers are allowed to open the doors and step down the vehicle. At this moment, the central lock unit 4 actuates the light emission element 2 to give off light. The light emission element 2 can be mounted to a rearview mirror 5 of the vehicle and preferably, the light emission element comprises a plurality of light-emitting diodes arranged in a matrix as shown in FIG. 3. Programming may be performed to control the plurality of light-emitting diodes to light progressively in an inside to outside direction of the vehicle body 1 and such a fashion of lighting the light-emitting diodes resembles opening of door, making it not possible for a vehicle coming from the rear side to wrongly regard the light emission element 2 as turning signal light. In this way, vehicles and pedestrians on the rear side of the vehicle can clearly realize that passengers of the vehicle is going to open vehicle door to step down shortly and they can slow down or move aside to avoid collision. As such, an effective alarm for vehicle door opening is provided.

Further, a plurality of light emission elements 2 can be arranged in matrix forms and mounted below the rearview mirrors 5 on both sides of a vehicle, so that when the light emission elements 2 are actuated to give off light, the vehicle driver may get immediately aware that the central lock unit 4 is unlocked.

As shown in FIG. 4, when a vehicle is moving or is stopped, if a passenger on the back seat inadvertently unlocks a door lock, the central lock unit 4 is also caused to unlock. Under such a condition, the vehicle driver can be immediately aware from the lighting of the light emission element 2 that the central lock unit 4 is being opened. As such, the driver can take action to immediately re-lock the central lock unit 4, in order to avoid any chance of causing danger. Further, when the driver completes a parking operation, the driver may identify if the central lock unit is locked by viewing at the light emission element 2.

Thus, as compared to the conventional devices, the present invention shows the following advantages:

(1) When a vehicle driver unlocks the central lock unit 4, the central lock unit 4 commands the control unit 3 to actuate the light emission element 2 to light and at this time, vehicle doors are not opened yet, so that the lighting signals vehicles and pedestrian coming from the rear side to reduce speed or move aside in order to allow the driver and passengers to open the vehicle doors and step down the vehicle in a safe manner.

(2) When the central lock unit 4 locked, the central lock unit 4 commands the control unit 3 to control the light emission element 2 to stop lighting, so that when the vehicle driver leaves the vehicle, the driver can identify if the central lock unit is properly locked by viewing at the light emission element 2.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An alarm light structure, comprising:
at least one light emission element, which is adapted to mount to a vehicle;
a control unit, which is electrically connected to the light emission element and controls actuation/de-actuation of the light emission element to give off light; and
a central lock unit, which is adapted to lock/unlock a vehicle door and is in electrical connection with the control unit, whereby when the central lock unit is unlocked, the control unit controls the light emission element to give off light.

2. The alarm light structure according to claim 1, wherein the light emission element comprises a light-emitting diode.

3. The alarm light structure according to claim 1, wherein the light-emitting diode is mounted inside a rearview mirror of the vehicle.

4. The alarm light structure according to claim 1, wherein the light-emitting diode is mounted below a rearview mirror of the vehicle.

5. The alarm light structure according to claim 1, wherein a plurality of light-emitting diodes is provided in an arrangement of matrix.

6. The alarm light structure according to claim 1, wherein a plurality of light-emitting diodes is provided in a linear arrangement.

7. The alarm light structure according to claim 1, wherein the central lock unit comprises a door lock of a vehicle door of the vehicle.
